(19) United States
(12) Patent Application Publication
(10) Pub. No.: US 2024/0081357 A1
(43) Pub. Date: Mar. 14, 2024

(54) ANTI-OXIDANT COMPOSITION

(71) Applicant: DUPONT NUTRITION BIOSCIENCES APS, Copenhagen (DK)

(72) Inventor: Lars Månsson, Kongens Lyngby (DK)

(21) Appl. No.: 18/192,941

(22) Filed: Mar. 30, 2023

Related U.S. Application Data
(63) Continuation of application No. 17/351,797, filed on Jun. 18, 2021, now abandoned.
Application No. 17/351,797 is a continuation of application No. 16/596,978, filed on Oct. 9, 2019, now abandoned.
Application No. 16/596,978 is a continuation of application No. 15/417,716, filed on Jan. 27, 2017, now abandoned.
Application No. 15/417,716 is a continuation of application No. 13/497,432, filed on May 3, 2012, now abandoned.

(30) Foreign Application Priority Data
Oct. 15, 2009 (GB) 0918074.6
Jul. 8, 2010 (GB) 1011487.4

(51) Int. Cl. A23B 5/14; A23L 3/3472; A23L 27/60; A23L 33/105

(52) U.S. Cl. CPC A23B 5/14; A23L 3/3472; A23L 27/60; A23L 33/105; A23V 2002/00

(57) ABSTRACT

The present invention provides an anti-oxidant composition comprising
(a) an extract obtained from or obtainable from a plant of the Labiatae family,
(b) an extract obtained from or obtainable from a plant of the genus Matricaria or of the genus Chamaemelum.

### CROSS-REFERENCE TO RELATED PATENT APPLICATIONS

This patent claims priority as a continuation under 35 USC § 121 to U.S. patent application Ser. No. 17/351,797 (filed Jun. 18, 2021), which, in turn, claims priority as a continuation under 35 USC § 121 to U.S. patent application Ser. No. 16/596,978 (filed Oct. 9, 2019), which, in turn, claims priority as a continuation under 35 USC § 121 to U.S. patent application Ser. No. 15/417,716 (filed Jan. 27, 2017), which, in turn, claims priority as a continuation under 35 USC § 121 to U.S. patent application Ser. No. 13/497,432 (filed May 3, 2012), which, in turn, claims priority under 35 USC § 371 as a national phase of Int'l Patent Appl. PCT/IB2010/054637 (filed Oct. 13, 2010; and published as Intl Publ. No. WO2011/045757 on Apr. 21, 2011), which, in turn, claims priority to United Kingdom Patent Appl. Nos. 0918074.6 (filed Oct. 15, 2009) and 1011487.4 (filed Jul. 8, 2010). The entire text of each of the above-referenced patent applications is incorporated by reference into this patent.

The present invention relates to a composition that exhibits an anti-oxidant action.

### BACKGROUND

Antioxidants are widely used in food products susceptible to oxidative degeneration. An antioxidant is defined by the Food and Drug Administration (21CFR 170.3) as “a substance used to preserve food by retarding deterioration, rancidity, or discoloration due to oxidation”. There is an increasing need to develop economical, natural and effective food preservative systems to meet the public demand for convenient, natural, safe, healthy, good quality food products with guaranteed shelf life. To this end spices or plant extracts can be used in food as antioxidants and to impart flavour. One advantage of such extracts is that they are perceived as natural ingredients when compared to chemical antioxidants such as ethylenediaminetetraacetic acid (EDTA), butyl hydroxyanisol (BHA) and butylated hydroxytoluene (BHT).

There are large number of antioxidants known based on naturally occurring plant materials. It is noted that these materials have varying degrees of efficacy. Moreover, the antioxidant levels required to ensure preservation safety may prove uneconomical, or are above levels acceptable due to regulatory and legislation constraints when present in amounts sufficient to offer the required protection.

The present invention alleviates the problems of the prior art.

In one aspect the present invention provides an anti-oxidant composition comprising
(a) an extract obtained from or obtainable from a plant of the Labiatae family,
(b) an extract obtained from or obtainable from a plant of the genus Matricaria or of the genus Chamaemelum.

In one aspect the present invention provides a process for preventing and/or inhibiting oxidation of a foodstuff, the process comprising the step of contacting the foodstuff with
(a) an extract obtained from or obtainable from a plant of the Labiatae family, and
(b) an extract obtained from or obtainable from a plant of the genus Matricaria or of the genus Chamaemelum.

In one aspect the present invention provides use of
(a) an extract obtained from or obtainable from a plant of the Labiatae family, and
(b) an extract obtained from or obtainable from a plant of the genus Matricaria or of the genus Chamaemelum,
for preventing and/or inhibiting oxidation of a foodstuff.

In one aspect the present invention provides kit for preparing a composition as defined herein, the kit comprising
(a) an extract obtained from or obtainable from a plant of the Labiatae family, and
(b) an extract obtained from or obtainable from a plant of the genus Matricaria or of the genus Chamaemelum,
in separate packages or containers; optionally with instructions for admixture and/or contacting and/or use.

Aspects of the invention are defined in the appended claims.

The present invention provides a synergistic combination of components for preventing and/or inhibiting oxidation in a material, such as foodstuff. This combination of components allows lower levels of the antioxidants to be used to provide effective action. This is particularly important in food applications where reduction of dosage is desired for commercial and regulatory reasons.

It will be understood by one skilled in the art that by the term ‘antioxidant’ it is meant a substance which reduces the amount of oxidation over a given period when compared to the oxidation that would occur in the absence of that substance or it is a meant a material which increase the time required for a given amount of oxidation to occur when compared to the oxidation that would occur in the absence of that substance.

Plants of the family Labiatae contain several well known herbs. Extracts from these plants have been shown to have antioxidant and, in some cases, antimicrobial activity (Nychas & Skandamis, 2003; Smid and Gorris, 1999; Loliger, 1989). Such extracts may be essential oils and oleoresins (extracts with essential oil content used in flavours and fragrances) or “deodorised”, extracts that have a high phenolic diterpene content and low level of flavour-inducing compounds.

Essential oils are extracted by simple steam distillation of the plant material. The most effective antioxidant compounds in rosemary and sage are reported to be carnosic acid, carnosol and rosmarinic acid (Cuvelier et a/. 1996). Carnosic acid, a phenolic diterpene (C₂₀H₂₈O₄), occurs naturally in leaves of plants of the Labiatae family, particularly rosemary and sage, but also thyme and marjoram. Dried leaves of rosemary or sage contain 1.5-2.5% carnosic acid and 0.3-0.4% carnosol (U.S. Pat. No. 6,231,896). Carnosol is an oxidative artefact of carnosic acid (Wenkert et al. J. Org. Chem 30:2931, 1965). The oxidation takes place in the presence of harvesting in the leaves left to dry in the air and if the leaves are subjected to extraction with solvents. Rosmanol may also be a product of the oxidation of carnosic acid.

Of the Labiatae plant family, rosemary and sage have antioxidant activity in foods that is mainly related to phenolic diterpenes such as carnosic acid and carnosol, as well as other phenolic compounds, including phenolic triterpenes such as betulinic acid, oleanolic acid and ursolic acid; and rosmarinic acid. The phenolic diterpenes, phenolic triterpenes and rosmarinic acid are distinct from the essential oils and oleoresins that are often used in flavours and fragrances. The high flavour and odour levels of essential oils is not conducive to their use in food.

Of plants of the genus Matricaria or of the genus Chamaemelum, such as chamomile, are also known to have antioxidant activity. This is mainly related to flavones such as apigenin-7-O-glucoside (A7G) and its derivatives, as well as other flavones.

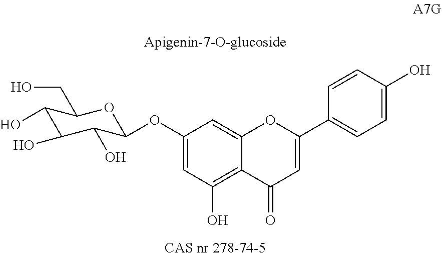 [SMILES: O=c1cc(-c2ccc(O)cc2)oc2cc(OC3OC(CO)C(O)C(O)C3O)cc(O)c12]

Details of A7G and its derivatives are disclosed by Svehliková, V et at Phytochemistry, 2004, 35, 2323. As for the active antioxidants of Labiatae plant family, the antioxidants from plants of the genus Matricaria or of the genus Chamaemelum are distinct from the essential oils and oleoresins that are often used in flavours and fragrances. The high flavour and odour levels of essential oils is not conducive to their use in food.

One skilled in the art would expect a combination of an extract from the Labiatae plant family and an extract from a plant of the genus Matricaria or of the genus Chamaemelum, to provide a simple additive antioxidant effect. However, studies described herein have demonstrated synergistic enhancement of antioxidant activity.

For ease of reference, these and further aspects of the present invention are now discussed under appropriate section headings. However, the teachings under each section are not necessarily limited to each particular section.

### PREFERRED ASPECTS

### Labiatae Extract

As discussed herein one extract used in the present invention is obtained from or is obtainable from a plant of the Labiatae family.

In one aspect the extract used in the present invention is obtained from a plant of the Labiatae family.

It will be appreciated by one skilled in the art that by the term “extract” or “extracts” it is meant any constituent of the plant which may be isolated from the whole plant.

In one aspect the extract used in the present invention is obtainable from a plant of the Labiatae family. It will be appreciated by one skilled in the art that an extract obtainable from a plant may be obtained from a plant or may be isolated from the plant, identified and then obtained from an alternative source, for example by chemical synthesis or enzymatic production. For example the extract may be produced by a eukaryotic or prokaryotic fermentation, by a process of genetic manipulation. The present applicant have recognised that products present in a plant of the Labiatae family may synergistically increase the activity of antioxidant material obtained or obtainable from a plant of the genus Matricaria or of the genus Chamaemelum. These products may be obtained from any source and will fall within the scope of the present invention.

The invention comprises use of a combination of an extract from a plant of the Labiatae family, such as rosemary (Rosmarinus officinalis) and antioxidant material obtained or obtainable from a plant of the genus Matricaria or of the genus Chamaemelum (Matricaria recurtita), that together give antioxidant activity in a food system. The extracts responsible for synergy in the present invention preferably refer to extracts of the plant family Labiatae that have been selectively extracted (“deodorised extracts”) to increase their phenolic diterpene content (such as carnosic acid). These deodorised extracts can be distinguished by their high phenolic diterpene content (for example greater than 3.5 wt. %) and their low level (less than 1 wt. %) of flavour-inducing compounds from plant essential oils and oleoresins that are used as flavours or fragrances. Essential oils are typically extracted by simple steam distillation of the plant material.

Essential oils comprise the various essential oils in plants having the odour or the flavour of the plant from which they were extracted. The essential oils are typically terpenoids often comprising monoterpenes. For example an antioxidant type of rosemary extract, which could be described as selectively extracted or deodorised, contains >3.5% wt. % phenolic diterpenes but less than 1 wt. % essential oils. A non-selective, flavouring extract contains 10-30 wt. % essential oils and a phenolic diterpene content of 2->3.5 wt. %.

An essential oil is commonly described as the volatile ethereal fraction obtained from a plant or plant part by a physical separation process such as distillation or chromatographic separation. Essential oils have also been described as a “group of odorous principles, soluble in alcohol and to a limited extent in water, consisting of a mixtures of esters, aldehydes, ketones and terpenes. Essential oils are typically obtained by distilling plants with water; the oil that separates from distillate usually has highly characteristic odors identified with the plant origin. The resulting mixture of organic compounds was thought, in the days of alchemists, to be the essence of the plant, hence the term “essential oil”.

In one preferred aspect the extract is a deodorised extract. Preferably the (deodorised) extract contains from 1.0 to 70 wt. % phenolic diterpenes, preferably 3.5 to 70 wt. % phenolic diterpenes and less than 1 wt. % essential oil. In one aspect the extract obtained from or obtainable from a plant of the Labiatae family contains phenolic diterpenes in an amount of at least 1 wt % based on the weight of extract obtained from or obtainable from a plant of the Labiatae family, such as in an amount of 1 to 95 wt % based on the weight of extract obtained from or obtainable from a plant of the Labiatae family, such as in an amount of 1 to 90 wt % based on the weight of extract obtained from or obtainable from a plant of the Labiatae family, such as in an amount of 1 to 85 wt % based on the weight of extract obtained from or obtainable from a plant of the Labiatae family, such as in an amount of 1 to 70 wt % based on the weight of extract obtained from or obtainable from a plant of the Labiatae family, such as in an amount of 1 to 50 wt % based on the weight of extract obtained from or obtainable from a plant of the Labiatae family, such as in an amount of 1 to 30 wt % based on the weight of extract obtained from or obtainable from a plant of the Labiatae family, such as in an amount of 1 to 20 wt % based on the weight of extract obtained from or obtainable from a plant of the Labiatae family, such as in an amount of 1 to 15 wt % based on the weight of extract obtained from or obtainable from a plant of the Labiatae family, such as in an amount of 1 to 10 wt % based on the weight of extract obtained from or obtainable from a plant of the Labiatae family.

In one preferred aspect the extract is or comprises a phenolic diterpene. Preferably the phenolic diterpene is carnosic acid.

In one aspect the extract obtained from or obtainable from a plant of the Labiatae family contains carnosic acid in an amount of at least 1 wt % based on the weight of extract obtained from or obtainable from a plant of the Labiatae family, such as in an amount of 1 to 95 wt % based on the weight of extract obtained from or obtainable from a plant of the Labiatae family, such as in an amount of 1 to 90 wt % based on the weight of extract obtained from or obtainable from a plant of the Labiatae family, such as in an amount of 1 to 85 wt % based on the weight of extract obtained from or obtainable from a plant of the Labiatae family, such as in an amount of 1 to 70 wt % based on the weight of extract obtained from or obtainable from a plant of the Labiatae family, such as in an amount of 1 to 50 wt % based on the weight of extract obtained from or obtainable from a plant of the Labiatae family, such as in an amount of 1 to 40 wt % based on the weight of extract obtained from or obtainable from a plant of the Labiatae family such as in an amount of 1 to 30 wt % based on the weight of extract obtained from or obtainable from a plant of the Labiatae family, such as in an amount of 1 to 25 wt % based on the weight of extract obtained from or obtainable from a plant of the Labiatae family, such as in an amount of 1 to 20 wt % based on the weight of extract obtained from or obtainable from a plant of the Labiatae family, such as in an amount of 1 to 10 wt % based on the weight of extract obtained from or obtainable from a plant of the Labiatae family, such as in an amount of 1 to 5 wt % based on the weight of extract obtained from or obtainable from a plant of the Labiatae family.

In one preferred aspect the extract contains flavour-inducing compounds and/or essential oils in an amount of less than 1 wt. % based on the extract. In one preferred aspect the extract contains flavour-inducing compounds and/or essential oils in an amount of less than 1 wt. % based on the composition.

Typically flavour-inducing compounds and/or essential oils are camphor, verbenone, borneol and alfa-terpineol.

In one preferred aspect the combined amount of camphor present in the extract is less than 1 wt. % (preferably less than 0.2 wt. %, more preferably less than 0.15 wt. %, more preferably less than 0.1 wt. %) based on the extract.

In one preferred aspect the combined amount of verbenone present in the extract is less than 1 wt. % (preferably less than 0.2 wt. %, more preferably less than 0.15 wt. %, more preferably less than 0.1 wt. %) based on the extract.

In one preferred aspect the combined amount of borneol present in the extract is less than 1 wt. % (preferably less than 0.2 wt. %, more preferably less than 0.15 wt. %, more preferably less than 0.1 wt. %) based on the extract.

In one preferred aspect the combined amount of alfa-terpineol present in the extract is less than 1 wt. % (preferably less than 0.2 wt. %, more preferably less than 0.15 wt. %, more preferably less than 0.1 wt. %) based on the extract.

In one preferred aspect the combined amount of camphor, verbenone, borneol and alfa-terpineol present in the extract is less than 1 wt. % (preferably less than 0.2 wt. %, more preferably less than 0.15 wt. %, more preferably less than 0.1 wt. %) based on the extract.

In one preferred aspect the extract contain less than 1 wt. % of plant essential oils and/or oleoresins based on the extract. In one preferred aspect the extract contain less than 1 wt. % of plant essential oils and/or oleoresins based on the composition.

In one preferred aspect the extract contains essential oils in an amount of less than 1 wt. % based on the extract. In one preferred aspect the extract contains essential oils in an amount of less than 1 wt. % based on the composition.

In one preferred aspect the plant of the Labiatae family is selected from rosemary, sage, oregano, marjoram, mint, balm, savoury and thyme. In one preferred aspect the plant of the Labiatae family is selected from rosemary, sage, oregano, marjoram, mint, balm, and savoury. It will be understood that these name cover all species and varieties of plants known by these names.

In one preferred aspect the plant of the Labiatae family is selected from rosemary (Rosmarinus officinalis L.), sage (Salvia officinalis L.) oregano (Origanum vulgare L.), marjoram (Origanum marjorana L.), mint (Mentha spp.), balm (Melissa officinalis L.), savoury (Satureia hortensis), thyme (Thymus vulgaris L.).

In one preferred aspect the plant of the Labiatae family is selected from rosemary (Rosmarinus officinalis L.), sage (Salvia officinalis L.), oregano (Origanum vulgare L.), marjoram (Origanum marjorana L.), mint (Mentha spp.), balm (Melissa officinalis L.), and savoury (Satureia hortensis).

In one preferred aspect the plant of the Labiatae family is selected from rosemary (Rosmarinus officinalis L.), sage (Salvia officinalis L.), marjoram (Origanum marjorana L.), mint (Mentha spp.), balm (Melissa officinalis L.), and savoury (Satureia hortensis).

In one preferred aspect the plant of the Labiatae family is rosemary.

In a further preferred aspect the phenolic diterpenes, phenolic triterpenes and rosmarinic acid are obtained by chemical synthesis.

Thus in highly preferred aspects the present invention provides
an anti-oxidant composition comprising (a) carnosic acid, (b) an extract obtained from or obtainable from a plant of the genus Matricaria or of the genus Chamaemelum.
a process for preventing and/or inhibiting oxidation of a foodstuff, the process comprising the step of contacting the foodstuff with (a) carnosic acid, and (b) an extract obtained from or obtainable from a plant of the genus Matricaria or of the genus Chamaemelum.
use of (a) carnosic acid, and (b) an extract obtained from or obtainable from a plant of the genus Matricaria or of the genus Chamaemelum, for preventing and/or inhibiting oxidation of a foodstuff.
a kit for preparing a composition as defined herein, the kit comprising (a) carnosic acid, and (b) an extract obtained from or obtainable from a plant of the genus Matricaria or of the genus Chamaemelum, in separate packages or containers; optionally with instructions for admixture and/or contacting and/or use.

### Matricaria/Chamaemelum Extract

As discussed herein one extract used in the present invention is obtained from or is obtainable from a plant of the genus Matricaria or of the genus Chamaemelum.

Plants of the genus Matricaria and plants of the genus Chamaemelum are commonly referred to as chamomile. The term chamomile may also include plants of the genus Anthemis. Thus in one aspect the extract of a plant of the genus Matricaria or a plant of the genus Chamaemelum, may be substituted entirely or in part by a plant of the genus Anthemis. Thus in further aspects, the present invention provides
an anti-oxidant composition comprising (a) an extract obtained from or obtainable from a plant of the Labiatae family, (b) an extract obtained from or obtainable from a plant of the genus Anthemis.
a process for preventing and/or inhibiting oxidation of a foodstuff, the process comprising the step of contacting the foodstuff with (a) an extract obtained from or obtainable from a plant of the Labiatae family, (b) an extract obtained from or obtainable from a plant of the genus Anthemis.
use of (a) an extract obtained from or obtainable from a plant of the Labiatae family, (b) an extract obtained from or obtainable from a plant of the genus Anthemis for preventing and/or inhibiting oxidation of a foodstuff.
a kit for preparing a composition as defined herein, the kit comprising (a) an extract obtained from or obtainable from a plant of the Labiatae family, (b) an extract obtained from or obtainable from a plant of the genus Anthemis, in separate packages or containers; optionally with instructions for admixture and/or contacting and/or use.

In one aspect the extract is obtained from or is obtainable from a plant of the genus Matricaria.

In one aspect the extract is obtained from or is obtainable from a plant of the genus Chamaemelum.

In one aspect the extract is a mixture of extract obtained from or is obtainable from a plant of the genus Matricaria and extract obtained from or is obtainable from a plant of the genus Chamaemelum.

In one aspect the extract used in the present invention is obtained from a plant of the genus Matricaria or of the genus Chamaemelum.

In one aspect the extract is obtained from a plant of the genus Matricaria.

In one aspect the extract is obtained from a plant of the genus Chamaemelum.

In one aspect extract (b) is from a plant selected from plants of the species Matricaria recurtita, Ormenis multicaulis, Eriocephalus punctulatus, Chamaemelum nobile (syn Anthemis nobilis), Anthemis arvensis, Anthemis cotula, Anthemis tinctoria and Matricaria discoidea. In one preferred aspect extract (b) is from a plant of the species Matricaria recurtita.

In one aspect the extract is a mixture of extract obtained from a plant of the genus Matricaria and extract obtained from a plant of the genus Chamaemelum.

It will be appreciated by one skilled in the art that by the term “extract” or “extracts” it is meant any constituent of the plant which may be isolated from the whole plant.

In one aspect the extract used in the present invention is obtainable from a plant of the genus Matricaria or of the genus Chamaemetum. It will be appreciated by one skilled in the art that an extract obtainable from a plant may be obtained from a plant or may be isolated from the plant, identified and then obtained from an alternative source, for example by chemical synthesis or enzymatic production. For example the extract may be produced by a eukaryotic or prokaryotic fermentation, by a process of genetic manipulation. The present applicant have recognised that products present in a plant of the genus Matricaria or of the genus Chamaemelum may synergistically increase the activity of antioxidant material obtained or obtainable from a plant of the Labiatae family. These products may be obtained from any source and will fall within the scope of the present invention.

The invention comprises use of a combination of an extract from a plant of the genus Matricaria or of the genus Chamaemelum, such as chamomile (Matricaria recurtita) and antioxidant material obtained or obtainable from a plant of the Labiatae family, that together give antioxidant activity in a food system.

In one preferred aspect the extract is or comprises a flavone. Preferably the flavone is apigenin-7-O-glucoside or a derivative thereof. Preferred derivatives of apigenin-7-O-glucoside are apigenin-7-O-(6″-malonyl-glucoside) and apigenin-7-O-(4″-acetyl-6″-malonyl-glucoside). Thus in one aspect the flavone is selected from apigenin-7-O-glucoside, apigenin-7-O-(6″-malonyl-glucoside), apigenin-7-O-(4″-acetyl-6″-malonyl-glucoside) and mixtures thereof. In one further aspect the flavone is at least apigenin-7-O-glucoside and optionally one or both of apigenin-7-O-(6″-malonyl-glucoside) and apigenin-7-O-(4″-acetyl-6″-malonyl-glucoside). In further preferred aspects the extract is or comprises
apigenin-7-O-glucoside, apigenin-7-O-(6″-malonyl-glucoside) and apigenin-7-O-(4″-acetyl-6″-malonyl-glucoside); or
apigenin-7-O-glucoside and apigenin-7-O-(6″-malonyl-glucoside); or
apigenin-7-O-glucoside and apigenin-7-O-(4″-acetyl-6″-malonyl-glucoside); or
apigenin-7-O-(6″-malonyl-glucoside) and apigenin-7-O-(4″-acetyl-6″-malonyl-glucoside); or
apigenin-7-O-glucoside; or
apigenin-7-O-(6″-malonyl-glucoside); or
apigenin-7-O-(4″-acetyl-6″-malonyl-glucoside)

In one aspect the flavone is apigenin-7-O-glucoside.

The structures of apigenin-7-O-(6″-malonyl-glucoside) and apigenin-7-O-(4″-acetyl-6″-malonyl-glucoside) are shown below

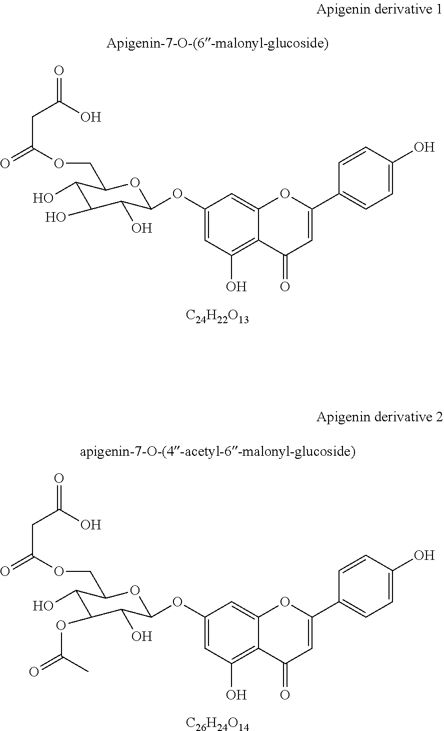 [SMILES: O=C(O)CC(=O)OCC1OC(Oc2cc(O)c3c(=O)cc(-c4ccc(O)cc4)oc3c2)C(O)C(O)C1O ; "C24H22O13" ; CC(=O)OC1C(O)C(COC(=O)CC(=O)O)OC(Oc2cc(O)c3c(=O)cc(-c4ccc(O)cc4)oc3c2)C1O ; "C26H24O14"]

In one aspect the extract obtained from or obtainable from a plant of the Chamaemelum family contains apigenin-7-O-glucoside, apigenin-7-O-(6″-malonyl-glucoside) and apigenin-7-O-(4″-acetyl-6″-malonyl-glucoside) in an combined amount of at least 0.1 wt % based on the weight of extract obtained from or obtainable from the plant of the genus Matricaria or of the genus Chamaemelum, such as in an amount of at least 0.2 wt % based on the weight of extract obtained from or obtainable from the plant of the genus Matricaria or of the genus Chamaemelum, such as in an amount of at least 0.5 wt % based on the weight of extract obtained from or obtainable from the plant of the genus Matricaria or of the genus Chamaemelum, such as in an amount of 0.1 to 20 wt % based on the weight of extract obtained from or obtainable from the plant of the genus Matricaria or of the genus Chamaemelum, such as in an amount of 0.1 to 10 wt % based on the weight of extract obtained from or obtainable from the plant of the genus Matricaria or of the genus Chamaemelum, such as in an amount of 0.1 to 5 wt % based on the weight of extract obtained from or obtainable from the plant of the genus Matricaria or of the genus Chamaemelum, such as in an amount of 0.2 to 3 wt % based on the weight of extract obtained from or obtainable from the plant of the genus Matricaria or of the genus Chamaemelum, such as in an amount of 0.2 to 2 wt % based on the weight of extract obtained from or obtainable from the plant of the genus Matricaria or of the genus Chamaemelum, such as in an amount of 0.5 to 2 wt % based on the weight of extract obtained from or obtainable from the plant of the genus Matricaria or of the genus Chamaemelum. It will be understood by one skilled in the art that one or more of apigenin-7-O-glucoside, apigenin-7-O-(6″-malonyl-glucoside) and apigenin-7-O-(4″-acetyl-6″-malonyl-glucoside) may not be present provided the combined total amounts of apigenin-7-O-glucoside, apigenin-7-O-(6″-malonyl-glucoside) and apigenin-7-O-(4″-acetyl-6″-malonyl-glucoside) which are present is within the recited range.

In one aspect the extract obtained from or obtainable from a plant of the Chamaemelum family contains apigenin-7-O-glucoside in an amount of at least 0.1 wt % based on the weight of extract obtained from or obtainable from the plant of the genus Matricaria or of the genus Chamaemelum, such as in an amount of at least 0.2 wt % based on the weight of extract obtained from or obtainable from the plant of the genus Matricaria or of the genus Chamaemelum, such as in an amount of at least 0.5 wt % based on the weight of extract obtained from or obtainable from the plant of the genus Matricaria or of the genus Chamaemelum, such as in an amount of 0.1 to 20 wt % based on the weight of extract obtained from or obtainable from the plant of the genus Matricaria or of the genus Chamaemelum, such as in an amount of 0.1 to 10 wt % based on the weight of extract obtained from or obtainable from the plant of the genus Matricaria or of the genus Chamaemelum, such as in an amount of 0.1 to 5 wt % based on the weight of extract obtained from or obtainable from the plant of the genus Matricaria or of the genus Chamaemelum, such as in an amount of 0.2 to 3 wt % based on the weight of extract obtained from or obtainable from the plant of the genus Matricaria or of the genus Chamaemelum, such as in an amount of 0.2 to 2 wt % based on the weight of extract obtained from or obtainable from the plant of the genus Matricaria or of the genus Chamaemelum, such as in an amount of 0.5 to 2 wt % based on the weight of extract obtained from or obtainable from the plant of the genus Matricaria or of the genus Chamaemelum.

In one preferred aspect the plant of the genus Matricaria or of the genus Chamaemelum is chamomile. It will be understood that these name cover all species and varieties of plants known by these names. In one preferred aspect the plant of the genus Matricaria or of the genus Chamaemelum is a plant of the species Matricaria recurtita. It is noted that this species may also be known as Matricaria chamomilla.

In a further preferred aspect the apigenin-7-O-glucoside is obtained by chemical synthesis.

Thus in highly preferred aspects the present invention provides
an anti-oxidant composition comprising (a) an extract obtained from or obtainable from a plant of the Labiatae family, (b) a flavone selected from apigenin-7-O-glucoside, derivatives thereof and combinations thereof (wherein the derivatives thereof are preferably selected from apigenin-7-O-(6″-malonyl-glucoside) and apigenin-7-O-(4″-acetyl-6″-malonyl-glucoside).
a process for preventing and/or inhibiting oxidation of a foodstuff, the process comprising the step of contacting the foodstuff with (a) an extract obtained from or obtainable from a plant of the Labiatae family, and (b) a flavone selected from apigenin-7-O-glucoside, derivatives thereof and combinations thereof (wherein the derivatives thereof are preferably selected from apigenin-7-O-(6″-malonyl-glucoside) and apigenin-7-O-(4″-acetyl-6″-malonyl-glucoside)
use of (a) an extract obtained from or obtainable from a plant of the Labiatae family, and (b) a flavone selected from apigenin-7-O-glucoside, derivatives thereof and combinations thereof (wherein the derivatives thereof are preferably selected from apigenin-7-O-(6″-malonyl-glucoside) and apigenin-7-O-(4″-acetyl-6″-malonyl-glucoside)
for preventing and/or inhibiting oxidation of a foodstuff.
a kit for preparing a composition as defined herein, the kit comprising (a) an extract obtained from or obtainable from a plant of the Labiatae family, and (b) a flavone selected from apigenin-7-O-glucoside, derivatives thereof and combinations thereof (wherein the derivatives thereof are preferably selected from apigenin-7-O-(6″-malonyl-glucoside) and apigenin-7-O-(4″-acetyl-6″-malonyl-glucoside),
in separate packages or containers; optionally with instructions for admixture and/or contacting and/or use.
an anti-oxidant composition comprising (a) an extract obtained from or obtainable from a plant of the Labiatae family, (b) apigenin-7-O-glucoside.
a process for preventing and/or inhibiting oxidation of a foodstuff, the process comprising the step of contacting the foodstuff with (a) an extract obtained from or obtainable from a plant of the Labiatae family, and (b) apigenin-7-O-glucoside.
use of (a) an extract obtained from or obtainable from a plant of the Labiatae family, and (b) apigenin-7-O-glucoside for preventing and/or inhibiting oxidation of a foodstuff.
a kit for preparing a composition as defined herein, the kit comprising (a) an extract obtained from or obtainable from a plant of the Labiatae family, and (b) apigenin-7-O-glucoside, in separate packages or containers; optionally with instructions for admixture and/or contacting and/or use.

### Composition

It will be understood that the components of the composition utilised in the present invention may be present in any amount to provide an antioxidant effect and in particular (a) extract obtained from or obtainable from a plant of the Labiatae family and (b) extract obtained from or obtainable from a plant of the genus Matricaria or of the genus Chamaemelum, are present in amounts to provide a synergistic anti-oxidant effect.

In one aspect the ratio of (a) extract obtained from or obtainable from a plant of the Labiatae family, to (b) extract obtained from or obtainable from a plant of the genus Matricaria or of the genus Chamaemelum, is from 30:1 to 1:20, such as 30:1 to 1:1, such as 20:1 to 1:20, such as 20:1 to 1:1, such as 15:1 to 1:20, such as 15:1 to 1:1, such as 10:1 to 1:20, such as 10:1 to 1:1, such as 5:1 to 1:20, such as 5:1 to 1:1., such as 1:1 to 1:15, such as 1:1 to 1:10, such as 1:1 to 1:5, such as 1:1 to 1:2, such as approximately 1:1.

In one aspect the ratio of (a) active anti-oxidant ingredient obtained from or obtainable from a plant of the Labiatae family, to (b) active anti-oxidant ingredient obtained from or obtainable from a plant of the genus Matricaria or of the genus Chamaemelum, is from 85:1 to 1:10, such as 85:1 to 1:5, such as 85:1 to 1:2, such as 85:1 to 1:1, such as 85:1 to 2:1, such as 85:1 to 5:1, such as 85:1 to 10:1, such as 85:1 to 15:1, such as 85:1 to 20:1, such as 70:1 to 1:1, such as 60:1 to 1:1, such as 50:1 to 1:1, such as 40:1 to 1:1, such as 30:1 to 1:1, such as 25:1 to 1:1, such as 20:1 to 1:1. In one aspect the ratio of (a) active anti-oxidant ingredient obtained from or obtainable from a plant of the Labiatae family, to (b) active anti-oxidant ingredient obtained from or obtainable from a plant of the genus Matricaria or of the genus Chamaemelum, is from 15:1 to 1:1, such as 10:1 to 1:1, such as 70:1 to 10:1, such as 60:1 to 10:1, such as 50:1 to 10:1, such as 40:1 to 10:1, such as 30:1 to 10:1, such as 25:1 to 15:1. In one aspect the ratio of (a) active anti-oxidant ingredient obtained from or obtainable from a plant of the Labiatae family, to (b) active anti-oxidant ingredient obtained from or obtainable from a plant of the genus Matricaria or of the genus Chamaemelum, is from 15:1 to 1:1, such as 15:1 to 2:1, such as 15:1 to 5:1, such as 15:1 to 10:1, such as 14:1 to 11:1, such as 13:1 to 11:1.

In one aspect the ratio of (a) phenolic diterpene, to (b) flavone, is from 85:1 to 1:10, such as 85:1 to 1:5, such as 85:1 to 1:2, such as 85:1 to 1:1, such as 85:1 to 2:1, such as 85:1 to 5:1, such as 85:1 to 10:1, such as 85:1 to 15:1, such as 85:1 to 20:1, such as 70:1 to 1:1, such as 60:1 to 1:1, such as 50:1 to 1:1, such as 40:1 to 1:1, such as 30:1 to 1:1, such as 25:1 to 1:1, such as 20:1 to 1:1. In one aspect the ratio of (a) phenolic diterpene, to (b) flavone, is from 15:1 to 1:1, such as 10:1 to 1:1, such as 70:1 to 10:1, such as 60:1 to 10:1, such as 50:1 to 10:1, such as 40:1 to 10:1, such as 30:1 to 10:1, such as 25:1 to 15:1 In one aspect the ratio of (a) phenolic diterpene, to (b) flavone, is from 15:1 to 1:1, such as 15:1 to 2:1, such as 15:1 to 5:1, such as 15:1 to 10:1, such as 14:1 to 11:1, such as 13:1 to 11:1.

In one aspect the ratio of (a) carnosic acid, to (b) apigenin-7-O-glucoside, is from 85:1 to 1:10, such as 85:1 to 1:5, such as 85:1 to 1:2, such as 85:1 to 1:1, such as 85:1 to 2:1, such as 85:1 to 5:1, such as 85:1 to 10:1, such as 85:1 to 15:1, such as 85:1 to 20:1, such as 70:1 to 1:1, such as 60:1 to 1:1, such as 50:1 to 1:1, such as 40:1 to 1:1. In one aspect the ratio of (a) carnosic acid, to (b) apigenin-7-O-glucoside, is from 30:1 to 1:1, such as 25:1 to 1:1, such as 20:1 to 1:1, such as 15:1 to 1:1, such as 10:1 to 1:1, such as 70:1 to 10:1, such as 60:1 to 10:1, such as 50:1 to 10:1, such as 40:1 to 10:1, such as 30:1 to 10:1, such as 25:1 to 15:1. In one aspect the ratio of (a) carnosic acid, to (b) apigenin-7-O-glucoside, is from 40:1 to 1:1, such as 40:1 to 5:1, such as 40:1 to 10:1, such as 40:1 to 15:1, such as 40:1 to 20:1, such as 40:1 to 25:1, such as 40:1 to 30:1, such as 35:1 to 30:1.

### Applications

The antioxidant composition may be utilised in any application in which inhibition of oxidation is required. As discussed herein, usage in foodstuffs is found to be particularly advantageous. In one aspect the present invention therefore provides
a process for preventing and/or inhibiting oxidation of a material, the process comprising the step of contacting the material with
(a) an extract obtained from or obtainable from a plant of the Labiatae family, and
(b) an extract obtained from or obtainable from a plant of the genus Matricaria or of the genus Chamaemelum.
use of
(a) an extract obtained from or obtainable from a plant of the Labiatae family, and
(b) an extract obtained from or obtainable from a plant of the genus Matricaria or of the genus Chamaemelum,
for preventing and/or inhibiting oxidation of a material.

Other possible applications include cosmetics.

### Foodstuff

The composition, process and use of the present invention may prevent and/or inhibit oxidation in any material. However, in view of the problems associated with oxidation of foodstuffs and in view of the particular effectiveness of the present invention in foodstuffs, preferably the composition is a foodstuff or may be added to a foodstuff. It will be appreciated by one skilled in the art that when the present composition is a foodstuff the essential components of (a) an extract obtained from or obtainable from a plant of the Labiatae family and (b) extract from a plant of the genus Matricaria or of the genus Chamaemelum must be present in the foodstuff. They may have been provided by one or more means. For example they may have been added in the form of a composition containing the extracts. The components may have been added to the foodstuff sequentially.

In one aspect the composition of the present invention is an antioxidant composition suitable for addition to a foodstuff.

Many foodstuffs may be protected by the present invention. Typical foodstuffs are raw meat, cooked meat, raw poultry products, cooked poultry products, raw seafood products, cooked seafood products, ready to eat meals, pasta sauces, pasteurised soups, mayonnaise, salad dressings, oil-in-water emulsions, margarines, low fat spreads, water-in-oil emulsions, dairy products, cheese spreads, processed cheese, dairy desserts, flavoured milks, cream, fermented milk products, cheese, butter, condensed milk products, ice cream mixes, soya products, pasteurised liquid egg, bakery products, confectionery products, fruit products, and foods with fat-based or water-containing fillings. Preferably the foodstuff is mayonnaise.

In one aspect the present composition is dosed in a foodstuff in an amount to provide the extract obtained from or obtainable from a plant of the genus Labiatae in an amount of no greater than 5000 ppm based on the weight of the foodstuff, such as no greater than 4000 ppm, such as no greater than 3000 ppm, such as no greater than 2000 ppm, such as no greater than 1000 ppm, such as no greater than 700 ppm, such as no greater than 500 ppm, such as no greater than 400 ppm, such as no greater than 300 ppm such as no greater than 200 ppm, such as no greater than 150 ppm, such as no greater than 100 ppm, such as no greater than 75 ppm, such as no greater than 50 ppm, such as no greater than 40 ppm, such as 1 to 150 ppm, such as 1 to 100 ppm, such as 1 to 50 ppm, such as 1 to 40 ppm, such as 10 to 150 ppm, such as 10 to 100 ppm, such as 10 to 50 ppm, such as 20 to 50 ppm based on the weight of the foodstuff.

In one aspect the present composition is dosed in a foodstuff in an amount to provide the extract obtained from or obtainable from a plant of the genus Matricaria or of the genus Chamaemelum in an amount of no greater than 5000 ppm based on the weight of the foodstuff, such as no greater than 4000 ppm, such as no greater than 3000 ppm, such as no greater than 2000 ppm, such as no greater than 1000 ppm, such as no greater than 700 ppm, such as no greater than 500 ppm, such as no greater than 400 ppm, such as no greater than 300 ppm based on the weight of the foodstuff, such as no greater than 200 ppm, such as no greater than 150 ppm, such as no greater than 100 ppm, such as no greater than 75 ppm, such as no greater than 50 ppm, such as no greater than 40 ppm, such as 1 to 150 ppm, such as 1 to 100 ppm, such as 1 to 50 ppm, such as 1 to 40 ppm, such as 10 to 150 ppm, such as 10 to 100 ppm, such as 10 to 50 ppm, such as 20 to 50 ppm based on the weight of the foodstuff.

In one aspect the present composition is dosed in a foodstuff in an amount to provide active anti-oxidant ingredient obtained from or obtainable from a plant of the genus Labiatae in an amount of no greater than 1000 ppm based on the weight of the foodstuff, such as no greater than 700 ppm, such as no greater than 500 ppm, such as no greater than 400 ppm, such as no greater than 200 ppm based on the weight of the foodstuff, such as no greater than 150 ppm, such as no greater than 100 ppm, such as no greater than 75 ppm, such as no greater than 50 ppm, such as no greater than 40 ppm, such as 1 to 100 ppm, such as 1 to 75 ppm, such as 1 to 50 ppm, such as 1 to 40 ppm, such as 10 to 100 ppm, such as 10 to 75 ppm, such as 10 to 50 ppm, such as 20 to 50 ppm based on the weight of the foodstuff.

In one aspect the present composition is dosed in a foodstuff in an amount to provide active anti-oxidant ingredient obtained from or obtainable from a plant of the genus Matricaria or of the genus Chamaemelum in an amount of no greater than 5000 ppm such as no greater than 4000 ppm, such as no greater than 3000 ppm, such as no greater than 2000 ppm such as no greater than 1000 ppm, such as no greater than 700 ppm, such as no greater than 500 ppm, such as no greater than 400 ppm, such as no greater than 200 ppm, such as no greater than 100 ppm, such as no greater than 75 ppm, such as no greater than 50 ppm, such as no greater than 40 ppm, such as no greater than 20 ppm based on the weight of the foodstuff, such as no greater than 15 ppm, such as no greater than 10 ppm, such as no greater than 7 ppm, such as no greater than 5 ppm, such as no greater than 4 ppm, such as 1 to 10 ppm, such as 1 to 7 ppm, such as 1 to 5 ppm, such as 2 to 5 ppm, such as 0.1 to 10 ppm, such as 0.1 to 7 ppm, such as 0.1 to 5 ppm.

In one aspect the present composition is dosed in a foodstuff in an amount to provide phenolic diterpene obtained from or obtainable from a plant of the genus Labiatae in an amount of no greater than 1000 ppm based on the weight of the foodstuff, such as no greater than 700 ppm, such as no greater than 500 ppm, such as no greater than 400 ppm, such as no greater than 200 ppm based on the weight of the foodstuff, such as no greater than 150 ppm, such as no greater than 100 ppm, such as no greater than 75 ppm, such as no greater than 50 ppm, such as no greater than 40 ppm, such as 1 to 100 ppm, such as 1 to 75 ppm, such as 1 to 50 ppm, such as 1 to 40 ppm, such as 10 to 100 ppm, such as 10 to 75 ppm, such as 10 to 50 ppm, such as 20 to 50 ppm based on the weight of the foodstuff.

In one aspect the present composition is dosed in a foodstuff in an amount to provide flavone obtained from or obtainable from a plant of the genus Matricaria or of the genus Chamaemelum in an amount of no greater than 5000 ppm such as no greater than 4000 ppm, such as no greater than 3000 ppm, such as no greater than 2000 ppm such as no greater than 1000 ppm, such as no greater than 700 ppm, such as no greater than 500 ppm, such as no greater than 400 ppm, such as no greater than 200 ppm, such as no greater than 100 ppm, such as no greater than 75 ppm, such as no greater than 50 ppm, such as no greater than 40 ppm, such as no greater than 20 ppm based on the weight of the foodstuff, such as no greater than 15 ppm, such as no greater than 10 ppm, such as no greater than 7 ppm, such as no greater than 5 ppm, such as no greater than 4 ppm, such as 1 to 10 ppm, such as 1 to 7 ppm, such as 1 to 5 ppm, such as 2 to 5 ppm such as 0.1 to 10 ppm, such as 0.1 to 7 ppm, such as 0.1 to 5 ppm based on the weight of the foodstuff.

In one aspect the present composition is dosed in a foodstuff in an amount to provide carnosic acid in an amount of no greater than 500 ppm, such as no greater than 400 ppm, such as no greater than 200 ppm, such as no greater than 100 ppm, such as no greater than 75 ppm, such as no greater than 50 ppm, such as no greater than 40 ppm, such as no greater than 200 ppm based on the weight of the foodstuff, such as no greater than 150 ppm, such as no greater than 100 ppm, such as no greater than 75 ppm, such as no greater than 50 ppm, such as no greater than 40 ppm, such as 1 to 100 ppm, such as 1 to 75 ppm, such as 1 to 50 ppm, such as 1 to 40 ppm, such as 10 to 100 ppm, such as 10 to 75 ppm, such as 10 to 50 ppm, such as 20 to 50 ppm based on the weight of the foodstuff.

In one aspect the present composition is dosed in a foodstuff in an amount to provide apigenin-7-O-glucoside in an amount of no greater than 2000 ppm such as no greater than 1000 ppm, such as no greater than 500 ppm, such as no greater than 400 ppm, such as no greater than 200 ppm, such as no greater than 100 ppm, such as no greater than 75 ppm, such as no greater than 50 ppm, such as no greater than 40 ppm, such as no greater than 20 ppm based on the weight of the foodstuff, such as no greater than 15 ppm, such as no greater than 10 ppm, such as no greater than 7 ppm, such as no greater than 5 ppm, such as no greater than 4 ppm, such as 1 to 10 ppm, such as 1 to 7 ppm, such as 1 to 5 ppm, such as 2 to 5 ppm such as 0.01 to 10 ppm, such as 0.01 to 7 ppm, such as 0.01 to 5 ppm based on the weight of the foodstuff.

### Additional Components

The composition of the present invention or the composition for use in the present invention may contain one or more additional components. However, in some aspects the antioxidant composition of the present invention (suitable for addition to a foodstuff) contains no additional components or contains no additional components that materially affect the properties of the composition. In these aspects the present invention provides
an anti-oxidant composition consisting essentially of (a) an extract obtained from or obtainable from a plant of the Labiatae family, (b) an extract obtained from or obtainable from a plant of the genus Matricaria or of the genus Chamaemelum.
a process for preventing and/or inhibiting oxidation of a foodstuff, the process comprising the step of contacting the foodstuff with a composition consisting essentially of (a) an extract obtained from or obtainable from a plant of the Labiatae family, and (b) an extract obtained from or obtainable from a plant of the genus Matricaria or of the genus Chamaemelum.
use of a composition consisting essentially of (a) an extract obtained from or obtainable from a plant of the Labiatae family, and (b) an extract obtained from or obtainable from a plant of the genus Matricaria or of the genus Chamaemelum, for preventing and/or inhibiting oxidation of a foodstuff.
a kit for preparing a composition as defined herein, the kit consisting essentially of (a) an extract obtained from or obtainable from a plant of the Labiatae family, and (b) an extract obtained from or obtainable from a plant of the genus Matricaria or of the genus Chamaemelum, in separate packages or containers; optionally with instructions for admixture and/or contacting and/or use.

In one preferred aspect the composition further comprises (c) an extract obtained from or obtainable from a plant of the Cynara family. In one preferred aspect the composition further comprises (c) an extract obtained from a plant of the Cynara family. Preferably the plant of the Cynara family is selected from an artichoke. Preferably the plant of the Cynara family is selected from Cynara scolymus and Cynara cardunculus. Preferably the plant of the Cynara family is Cynara scolymus.

In one preferred aspect the composition further comprises a carrier. Preferably the carrier is selected from propylene glycol, maltodextrin, sugar, salt, ethanol, water, protein, glycerol, medium chain triglyceride (MCT oil), and vegetable oil.

In one preferred aspect the composition further comprises an emulsifier. Preferably the emulsifier is selected from polyoxyethylene sorbitan esters (polysorbates), polyoxyethylene stearate, mono- and diglycerides of fatty acids, mono- and diglycerides esters further esterified with a dibasic organic acid selected from acetic acid, lactic acid, citric acid and mono- and diacetyl tartaric acid or mixtures thereof, lecithin, polyglycerol esters of fatty acids, polyglycerol polyricinoleate, sucrose esters of fatty acids, sucroglycerides, propylene glycol esters of fatty acids, sorbitan esters of fatty acids, sodium and calcium salt of stearoyl-2-lactylate, sodium, potassium, calcium and magnesium salts of fatty acids and ammonium phosphatides.

### Process

As discussed herein in one aspect the present invention provides a process for preventing and/or inhibiting oxidation of a foodstuff, the process comprising the step of contacting the foodstuff with a composition comprising (a) an extract obtained from or obtainable from a plant of the Labiatae family, and (b) an extract obtained from or obtainable from a plant of the genus Matricaria or of the genus Chamaemelum.

In one aspect the extract obtained from or obtainable from a plant of the Labiatae family, and the extract obtained from or obtainable from a plant of the genus Matricaria or of the genus Chamaemelum are added to the foodstuff together.

In one aspect the extract obtained from or obtainable from a plant of the Labiatae family, and the extract obtained from or obtainable from a plant of the genus Matricaria or of the genus Chamaemelum are added to the foodstuff sequentially.

Thus the present invention provides in one aspect an antioxidant composition which may be added to a range of materials such as food systems and in another aspect a combination of two separate products which may added sequentially to materials such as food products.

The present invention will now be described in further detail by way of example only with reference to the accompanying figures in which:

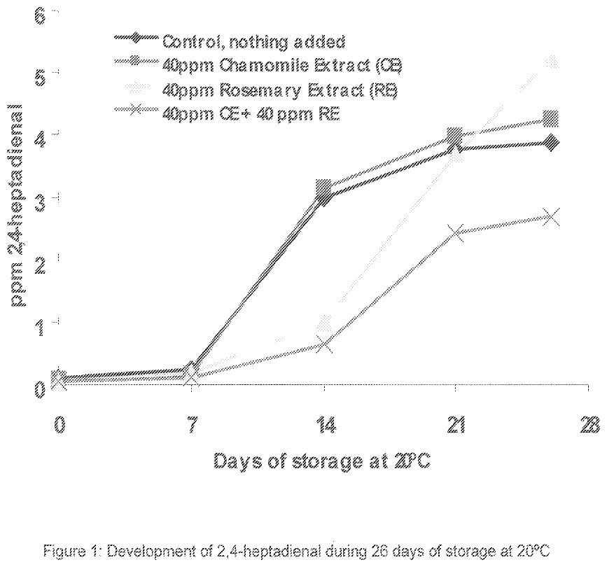

FIG. 1 shows the development of 2,4-heptadienal during 26 days of storage at 20° C. as described further in the below Examples; and

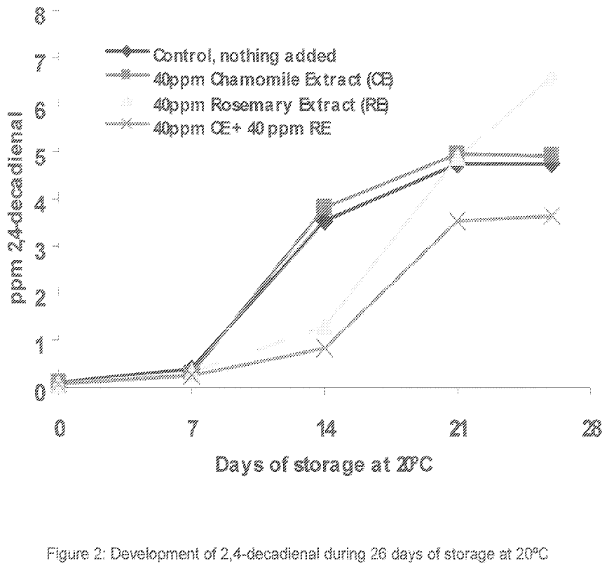

FIG. 2 shows the development of 2,4-decadienal during 26 days of storage at 20° C. as described further in the below Examples.

The present invention will now be described in further detail in the following examples.

### Examples

Two individual mayonnaise trials were conducted in respect of the synergistic interaction between chamomile extract (CE) and a phenolic diterpene based rosemary extract (RE).

Determination of secondary oxidation products by gas chromatography-mass-spectroscopy with selecting ion monitoring (GC-MS-SIM) revealed a synergistic interaction between the CE and RE. As single ingredient, CE was ineffective, but in combination with RE a strong synergism appeared in delaying the development of key secondary oxidation products (2,4-heptadienal and 2,4-decadienal).

### Plant Extracts Used

Rosemary Ex. was a hydroalcoholic extract from Rosmarinus officinalis L. containing min. 70 wt % phenolic diterpenes (which includes carnosic acid) and containing 70 wt % carnosic acid. Article no. E070143-70 available from Danisco A/S, Denmark.

Chamomile Extract was a hydroalcoholic extract from Matricaria recurita containing 4.6% flavones (which includes apigenin-7-O-glucoside, apigenin-7-O-(6″-malonyl-glucoside) and apigenin-7-O-(4″-acetyl-6″-malonyl-glucoside)) and containing apigenin-7-O-glucoside, apigenin-7-O-(6″-malonyl-glucoside) and apigenin-7-O-(4″-acetyl-6″-malonyl-glucoside) is a combined total of 4.0 wt %. Article no. E070143-93 available from Danisco A/S, Denmark.

### Experimental Procedure

### Mayonnaise Trial I

The mayonnaises were produced using the recipe in table 1 and procedures outlined below. All ingredients in mayonnaise were of food-grade quality. Samplings were done within 26 days according to the schematised sampling plan in table 2.

TABLE 1
Mayonnaise recipes. Gram of
ingredients used to produce 8 kg batches

| | | | | Mayonnaise |
|---|---|---|---|---|
| | | | | added |
| | | Mayon- | Mayon- | 40 ppm |
| | Mayon- | naise | naise | chamomile |
| | naise | added | added | ex. and |
| | without | 40 ppm | 40 ppm | 40 ppm |
| | anti- | Chamomile | Rosemary | Rosemary |
| | oxidants | Extract | Extract | Ex. |
| Ingredient | (CTR) | (CE) | (RE) | (CE + RE) |
| Water | 800.00 | 799.68 | 799.68 | 799.36 |
| Canola Oil | 6400.00 | 6400.00 | 6400.00 | 6400.00 |
| Sodium Chloride | 56.00 | 56.00 | 56.00 | 56.00 |
| Sugar | 80.00 | 80.00 | 80.00 | 80.00 |
| Potassium Sorbate | 8.00 | 8.00 | 8.00 | 8.00 |
| Grindsted ® FF5105 | 8.00 | 8.00 | 8.00 | 8.00 |
| Egg Yolk | 360.00 | 360.00 | 360.00 | 360.00 |
| Vinegar 10% | 240.00 | 240.00 | 240.00 | 240.00 |
| Mustard | 40.00 | 40.00 | 40.00 | 40.00 |
| Chamomile Extract | | 0.32 | | 0.32 |
| Rosemary Extract | | | 0.32 | 0.32 |
| Water | 6.00 | 6.00 | 6.00 | 6.00 |
| Ethanol (96%) | 2.00 | 2.00 | 2.00 | 2.00 |
| Total | 8000.00 | 8000.00 | 8000.00 | 8000.00 |

1. Dissolve sodium chloride, sugar and potassium sorbate in ¾ parts of the water in the funnel of a FrymaKoruma Disho Al 5 mixer (Romaco FrymaKoruma, Germany), while mixing at 3000 rpm and stirring at 60 rpm in a vacuum of 500 mbar for 1 minute.
2. Dissolve extracts in mixture of 6 g water and 2 g ethanol and add the mixture to the water phase.
3. Make a slurry of GRINDSTED® FF 5105 and approx. 30 g canola oil, and pump the slurry into the water phase at 3000 rpm in a vacuum (500 mbars) and continue mixing for 1 minute.
4. Add egg yolk and the rest of the water, while mixing at 3000 rpm and stirring at 60 rpm in a vacuum of 500 mbars and continue mixing for 3 minutes.
5. Emulsify the rest of the canola oil at 3500 rpm and continue mixing for 2 minutes.
6. Add vinegar and mustard while mixing at 3500 rpm and stirring at 60 rpm in a vacuum of 300 mbars for 1 minute.
7. Finally, mixing speed was decreased to 2500 rpm and stirring at 60 rpm in a vacuum of 300 mbar and held for 30 seconds before each batch was filled (temperature 25° C.) into food-approved DUMA PEHD plastic containers (150 ml) with 120 g±10 g (allowing headspace of approx. 10-20%).

TABLE 2
Sampling plan

| Days of storage | 0 | 7 | 14 | 21 | 26 |
|---|---|---|---|---|---|
| Peroxide value (oil) | X | | | | |
| ISC-OES metal analysis | X | | | | |
| GC-MS-SIM analysis* | X | x | x | x | x |
| Sensory evaluation | X | x | x | x | x |
| Surface colour (Lab-value) | X | | | | x |

*Samples were stored at −20° C. for approx. 1 month before the methanol extraction of volatiles and the GC-MS-SIM analysis.

### Mayonnaise Trial II

The mayonnaises were produced using the recipe in table 3 and procedures outlined below. Samplings were done after 1 and 14 days of storage at 20° C. in the dark according to the sampling plan in table 4.

TABLE 3
Mayonnaise recipes. Gram of ingredients used to produce
8 kg batches

| | | | | Mayon- | |
|---|---|---|---|---|---|
| | | | | naise | |
| | | Mayon- | Mayon- | added | |
| | | naise | naise | 60 ppm | |
| | Mayon- | added | added | chamomile | Mayon- |
| | naise | 60 ppm | 40 ppm | ex. and | naise |
| | without | Cham | Rose | 40 ppm | without |
| | anti- | mile | mary | Rosemary | anti- |
| | oxidants | Extract | Extract | Ex. | oxidants |
| Ingredient | (CTR_A) | (CE) | (RE) | (CE + RE) | (CTR_B) |
| Water | 800.00 | 799.52 | 799.68 | 799.20 | 800.00 |
| Canola Oil | 6400.00 | 6400.00 | 6400.00 | 6400.00 | 6400.00 |
| Sodium | 56.00 | 56.00 | 56.00 | 56.00 | 56.00 |
| Chloride | | | | | |
| Sugar | 80.00 | 80.00 | 80.00 | 80.00 | 80.00 |
| Potassium | 8.00 | 8.00 | 8.00 | 8.00 | 8.00 |
| Sorbate | | | | | |
| Grindsted ® | 8.00 | 8.00 | 8.00 | 8.00 | 8.00 |
| FF5105 | | | | | |
| Egg Yolk | 360.00 | 360.00 | 360.00 | 360.00 | 360.00 |
| Vinegar 10% | 240.00 | 240.00 | 240.00 | 240.00 | 240.00 |
| Mustard | 40.00 | 40.00 | 40.00 | 40.00 | 40.00 |
| Rosemary | | | 0.32 | 0.32 | |
| Extract | | | | | |
| Chamomile | | 0.48 | | 0.48 | |
| Extract | | | | | |
| Water | 6.00 | 6.00 | 6.00 | 6.00 | 6.00 |
| Ethanol | 2.00 | 2.00 | 2.00 | 2.00 | 2.00 |
| Total | 8000.00 | 8000.00 | 8000.00 | 8000.00 | 8000.00 |

1. Dissolve sodium chloride, sugar and potassium sorbate in % parts of the water in the funnel of a FrymaKoruma Disho A15 mixer (Romaco FrymaKoruma, Germany), while mixing at 3000 rpm and stirring at 60 rpm in a vacuum of 500 mbar for 1 minute.
2. Dissolve extracts in mixture of 6 g water and 2 g ethanol and add the mixture to the water phase.
3. Make a slurry of GRINDSTED® FF 5105 and approx. 30 g canola oil, and pump the slurry into the water phase at 3000 rpm in a vacuum (500 mbars) and continue mixing for 1 minute.
4. Add egg yolk and the rest of the water, while mixing at 3000 rpm and stirring at 60 rpm in a vacuum of 500 mbars and continue mixing for 3 minutes.
5. Emulsify the rest of the canola oil at 3500 rpm and continue mixing for 2 minutes.
6. Add vinegar and mustard while mixing at 3500 rpm and stirring at 60 rpm in a vacuum of 300 mbars for 1 minute.
7. Finally, mixing speed was decreased to 2500 rpm and stirring at 60 rpm in a vacuum of 300 mbar and held for 30 seconds before each batch was filled (temperature 25° C.) into food-approved DUMA PEHD plastic containers (150 ml) with 120 g±10 g (allowing headspace of approx. 10-20%).

TABLE 4
Sampling plan

| Days of storage | 1 | 14 |
|---|---|---|
| Peroxide value (oil) | x | |
| ISC-OES metal analysis | x | |
| GC-MS-SIM-analysis* | x | x |

*Samples were stored at −20° C. for approx. 4 months before the methanol extraction of volatiles and the GC-MS-SIM analysis.

### Methods

### Determination of Phenolic Diterpenes in Rosemary Extract

The antioxidant activity of rosemary extract is primarily related to the content of phenolic diterpenes. The content was analysed in duplicates using method based on high pressure liquid chromatography (HPLC), according to Thorsen & Hildebrandt (2003).

### Determination of Peroxide Value of Canola Oil

The peroxide value of canola oil was determined in duplicates by potentiometric titration according to: The American Oil Chemists' Society: Official Methods and Recommended Practices of The AOCS, 5^{th} Edition, Method: Cd 8-53.

### Determination of Metals in Mayonnaises by Inductively Coupled Plasma-Optical Emission Spectroscopy (ICP-OES)

The content of Cu, Fe, Ni and Zn was measured in triplicates by Inductively Coupled Plasma-Optical Emission Spectroscopy (ICP-OES) using a Varian Vista MPX (Varian, Palo Alto, CA). The analysis of elements was done according to the Official Methods of Analysis of the AOAC International, 16^{th} Edition, Methods: 965.09, 977,29, 985,01, 984,27.

### Sensory Evaluation of Mayonnaises

The number of days before rancid off-taste was first noticed until the product was unacceptable was evaluated by a panel of 2 people. Additional observations, e.g. extract notes, acidity, colour issues were further judged.

Determination of Oxidation Products in Mayonnaises by Gas Chromatography-Mass Spectrometry with Selected Ion Monitoring (GC-MS-SIM) Analysis.

2,4-heptadienal and 2,4-decadienal were determined in triplicates by gas chromatography-mass spectrometry with selected ion monitoring (GC-MS-SIM) analysis using an Agilent 6890N GC/Agilent 5973N MSD system.

To 0.5 g (+/−0.1g) of mayonnaise were added 10 ml methanol and internal standard (hexyl hexanoate) corresponding to 10 mg/kg. Then the slurry was shaken for 15 min on a shaker at 1000 rpm and placed in freezer overnight. An aliquot of the supernatant methanol phase was subsequently transferred to a GC-injection vial.

A calibration was performed in the range 0-40 mg/kg by adding a stock solution of 2,4-T,C-heptadienal and 2,4-T,C-decadienal and internal standard directly to methanol. In the calculations, the response from the 2,4-T,T isomers was added to the response from the 2,4-T,C-isomers, and a total was reported.

### Results

### Determination of Phenolic Diterpene Content in Rosemary Extract

The content of carnosol, carnosic acid and 12-O-methyl-carnosic acid were analysed in the rosemary extract by HPLC and results (g/100 g) are schematized in table 5. Carnosic acid was the major component of the phenolic diterpenes in the rosemary extract.

TABLE 5
Active components in Rosemary Extract

| | | | Carnosic | 12-O-Methyl | |
|---|---|---|---|---|---|
| | | Carnosol | acid | Carnosic | Total |
| Product | E-number | wt. % | wt. % | Acid wt. % | wt. % |
| Rosemary | E070143-70 | 4.6 | 70.1 | 10.1 | 84.8 |
| Extract | | | | | |

### Peroxide Value of Canola Oil

The Canola Oil (COLZAO™ Canola oil, Aarhus Karlsham, Denmark) used in the two trials were kept refrigerated in 190 kg sealed drums until the production of the mayonnaise. A sample of the oil was analysed immediately after opening the container and before the production of the mayonnaises. Results were calculated as meq/kg oil as presented in table 6.

TABLE 6
Peroxide values of the Canola Oil used in mayonnaise trial I & II.

| Trial | | Analytical result |
|---|---|---|
| no. | Lot. no./production date | (meq/kg oil) |
| I | 1000147444/Mar. 20, 2009 | 0.7 |
| II | 1000150000/Mar. 31, 2009 | 0.9 |

### Determination of Metals in Mayonnaises by Inductively Coupled Plasma-Optical Emission Spectroscopy (ICP-OES)

The unprotected control batch was analysed in triplicates for the content of Cu, Fe, Ni and Zn by Inductively Coupled Plasma-Optical Emission Spectroscopy (ICP-OES). Table 7 shows the average values of metals in mg/kg product. The copper content was approx. 7 times higher in mayonnaises produced in trial II than in trial I. The raw material responsible for the high copper variation monitored in trial I & II was not identified.

TABLE 7
Triplicate determination of Cu, Fe, Ni an Zn in ppm
(mg/kg mayonnaise) based on ICP-OES.

| Trial no. | Sample ID | ppm Cu | ppm Fe | ppm Ni | ppm Zn |
|---|---|---|---|---|---|
| I | CTR | 0.1 | 2 | <0.1 | 1.4 |
| II | CTR_A | 0.7 | 2.2 | 0.1 | 1.3 |

### Oxidative Stability, Mayonnaise Trial I

Determination of Oxidation Products by Gas Chromatography-Mass Spectrometry with Selected Ion Monitoring (GC-MS-SIM) Analysis.

Oxidation of polyunsaturated fatty acid (PUFA) oils produces a complex mixture of volatile secondary oxidation products, which cause particularly objectionable off-flavours. 2,4-heptadienal and 2,4-decadienal have previously been identified as one of the important markers for oxidation in emulsions, such as mayonnaise and milk emulsions (Hartvigsen et al. 2000; Let et at., 2004).

Average values (mg/kg mayonnaise) of 2,4-heptadienal and 2,4-decadienal determined in duplicates by GC-MS-SIM are presented in Table 8 and 9 and graphically viewed in FIGS. 1 & 2.

TABLE 8
Duplicate determination of 2,4-heptadienal (mg/kg mayonnaise)
during 26 days of storage at 20° C. One-way analysis of variance
(ANOVA) at each day and Tukey's test. Batches followed by
same letter not significant different using 0.05 levels of significance.

| | ppm 2,4-heptadienal | | | |
|---|---|---|---|---|
| | Control, | 40 ppm | 40 ppm | 40 ppm |
| Days of | nothing | Chamomile | Rosemary | CE + 40 ppm |
| storage | added (CTR) | Extract (CE) | Extract (RE) | RE (CE + RE) |
| 0 | 0.11^{b} ± 0.01 | 0.08^{ab} ± 0.02 | 0.07^{a} ± 0.01 | 0.06^{a} ± 0.01 |
| 7 | 0.26^{c} ± 0.02 | 0.17^{ab} ± 0.01 | 0.19^{b} ± 0.05 | 0.12^{a} ± 0.02 |
| 14 | 2.98^{c} ± 0.13 | 3.15^{c} ± 0.23 | 0.99^{b} ± 0.06 | 0.66^{a} ± 0.04 |
| 21 | 3.76^{b} ± 0.21 | 3.99^{b} ± 0.90 | 3.67^{b} ± 0.14 | 2.43^{a} ± 0.18 |
| 26 | 3.88^{ab} ± 0.64 | 4.26^{b} ± 0.93 | 5.23^{b} ± 0.85 | 2.70^{a} ± 0.15 |

TABLE 9
Duplicate determination of 2,4-decadienal (mg/kg mayonnaise)
during 26 days of storage at 20° C. One-way analysis of variance
(ANOVA) at each day and Tukey's test. Batches followed by
same letter not significant different using 0.05 levels of significance.

| | ppm 2,4-decadienal | | | |
|---|---|---|---|---|
| | Control, | 40 ppm | 40 ppm | 40 ppm |
| Days of | nothing | Chamomile | Rosemary | CE + 40 ppm |
| storage | added (CTR) | Extract (CE) | Extract (RE) | RE (CE + RE) |
| 0 | 0.12^{c} ± 0.02 | 0.10^{bc} ± 0.02 | 0.07^{ab} ± 0.02 | 0.05^{a} ± 0.01 |
| 7 | 0.41^{b} ± 0.04 | 0.30^{a} ± 0.02 | 0.33^{ab} ± 0.06 | 0.26^{a} ± 0.03 |
| 14 | 3.55^{c} ± 0.18 | 3.84^{c} ± 0.29 | 1.28^{b} ± 0.05 | 0.82^{a} ± 0.04 |
| 21 | 4.74^{a} ± 0.30 | 4.96^{a} ± 1.40 | 4.90^{a} ± 0.23 | 3.53^{a} ± 0.35 |
| 26 | 4.76^{ab} ± 1.07 | 4.93^{ab} ± 1.67 | 6.62^{b} ± 1.35 | 3.63^{a} ± 0.22 |

A one-way analysis of variance (ANOVA) using Tukey's test with 0.05 levels of significance was used to compare treatments at each storage day. The overall strongest antioxidant activity was demonstrated for the combined treatment with 40 ppm CE+40 ppm RE. The treatment with RE alone was significant within the first 14 days of storage, where after a prooxidant activity of RE were indicated, but not statistically proven.

2-factor interactions were further studied using 50-50 multivariate analysis of variance (50-50 Manova) described by Langsrud (2000, 2002). The dataset consisted of standardised (1/stdev) responses of 2,4-heptadienal and 2,4-decadienal for the 4 treatments (CTR, CE, RE, CE+RE) at all sampling days (0, 7, 14, 21 & 26 days). The analysis confirmed a 2-factor interaction between CE and RE on the inhibition of 2,4-heptadienal (p_{RE*CE}<0.001) and 2,4-decadienal (p_{RE*CE}<0.01). The fact that, chamomile extract interacted synergistically with rosemary extract has not earlier been described in literature.

### Sensory Evaluation

The products were evaluated by a panel of 2 people, rather than a full-scale panel. This small panel was able to identify any obvious ‘off tastes’. The sensory evaluation confirmed the strong antioxidant activity of the combined mixture of rosemary extract and chamomile (RE+CE). Of further note was the fact, that no off-flavour or discolouration was detected in any of the antioxidant treated batches.

TABLE 10
Sensory evaluation of rancidity, extract notes and colour
in mayonnaises stored at 20° C. for 26 days.

| | Oxidation in | |
|---|---|---|
| | mayonnaise | |
| | stored at 20° C. | |
| | Days until rancid | Other |
| | off-taste was: first | observations, |
| | noticed (. . .) | colour issues, |
| | & product | extract |
| Treatment | was unacceptable | notes etc. |
| Control. nothing added | (14) 14 | Not detected |
| 40 ppm Chamomile Extract (CE) | (21) 26 | Not detected |
| 40 ppm Rosemary Extract (RE) | (21) 26 | Not detected |
| 40 ppm CE + 40 ppm RE | (26) more than 26 | Not detected |

### Determination of Surface Lab-Colour by Tri-Stimulus Colorimeter

The surface Lab-colour was determined in duplicates after 0 and 26 days of storage using a Minolta Colormeter and the results are presented in Table 11.

A two-way analysis of variance (ANOVA) revealed no treatment (p>0.05) or days effects (p>0.05), which corresponds with the aforementioned sensory observation.

TABLE 11
Duplicate determination of the surface Lab-colour.

| | | Control, | 40 ppm | 40 ppm | 40 ppm |
|---|---|---|---|---|---|
| Days | | nothing | Chamomile | Rosemary | CE + |
| of | Lab- | added | Extract | Extract | 40 ppm RE |
| storage | value | (CTR) | (CE) | (RE) | (CE + RE) |
| 0 | L-value | 83.9 ± 0.2 | 84.5 ± 1.5 | 83.5 ± 1.0 | 84.4 ± 0.0 |
| 26 | L-value | 83.0 ± 0.6 | 83.7 ± 0.4 | 82.6 ± 1.3 | 84.3 ± 1.4 |
| 0 | a-value | −2.1 ± 0.0 | −2.0 ± 0.0 | −2.1 ± 0.1 | −2.1 ± 0.1 |
| 26 | a-value | −2.0 ± 0.0 | −1.9 ± 0.1 | −1.8 ± 0.3 | −2.0 ± 0.0 |
| 0 | b-value | 13.9 ± 0.0 | 13.9 ± 0.2 | 13.4 ± 1.2 | 14.0 ± 0.1 |
| 26 | b-value | 14.4 ± 0.1 | 14.2 ± 0.3 | 14.8 ± 0.2 | 14.8 ± 0.0 |

### Oxidative Stability, Mayonnaise Trial II

In a complex matrix like a food emulsion system several factors may influence the initiation and progress of lipid autoxidation. The use of gently processing conditions during the emulsification of the emulsion, depletion of oxygen and metals as well as the use of an oil of a good initial quality are some of the most important factors, which can influence the oxidative deterioration. The oil used in both trials had a satisfying quality with comparable peroxide values of 0.7 meq/kg and 0.9 meq/kg, respectively. The copper content in finished products, however, ranged from 0.1 ppm in trial I to 0.7 ppm in trial II. The higher copper content match the monitored faster development of both 2,4-heptadienal and 2,4-decadienal in trial II than compared to the ones produced in trial I (compare tables 8 & 9 with tables 12 & 13).

Determination of Oxidation Products by Gas Chromatography-Mass Spectrometry with Selected Ion Monitoring (GC-MS-SIM) Analysis.

A one-way analysis of variance (ANOVA) using Tukey's test with 0.05 levels of significance was used to compare treatments at day 1 and day 14. As it was the case in trial I, the combined treatment (CE+RE) was found significant more effective than treatment with RE alone. The treatment with CE alone, was prooxidant after 14 days in comparison to CTR_B, but not in comparison to CTR_A.

TABLE 12
Duplicate determination of 2,4-heptadienal (mg/kg mayonnaise) after
and 14 days of storage at 20° C. One-way analysis of variance
(ANOVA) at each day and Tukey's test. Batches followed by
same letter not significant different using 0.05 levels of significance.

| | | 2,4- | 2,4- |
|---|---|---|---|
| | | heptadienal | heptadienal |
| | | Storage: | Storage: |
| ID | Treatment | 1 days | 14 days |
| CTR_A | Control nothing added | 0.43 ^{b} ± 0.07 | 14.59 ^{cd} ± 1.38 |
| CTR_B | Control nothing added | 0.26 ^{a} ± 0.02 | 14.12 ^{c} ± 0.79 |
| CE | 60 ppm Chamomile | 0.28 ^{a} ± 0.01 | 16.18 ^{d} ± 0.48 |
| | Extract (CE) | | |
| RE | 40 ppm Rosemary | 0.30 ^{a} ± 0.02 | 9.44 ^{b} ± 0.15 |
| | Extract (RE) | | |
| RE + CE | 60 ppm CE + ppm RE | 0.22 ^{a} ± 0.02 | 4.78 ^{a} ± 0.59 |

TABLE 13
Duplicate determination of 2,4-decadienal (mg/kg mayonnaise) after
and 14 days of storage at 20° C. One-way analysis of variance
(ANOVA) at each day and Tukey's test. Batches followed by same
letter not significant different using 0.05 levels of significance.

| | | 2,4- | 2,4- |
|---|---|---|---|
| | | decadienal | decadienal |
| | | Storage: | Storage: |
| ID | Treatment | 1 days | 14 days |
| CTR_A | Control nothing added | 0.62 ^{b} ± 0.09 | 18.16 ^{cd} ± 1.70 |
| CTR_B | Control nothing added | 0.32 ^{a} ± 0.02 | 16.14 ^{c} ± 0.74 |
| CE | 60 ppm Chamomile | 0.28 ^{a} ± 0.01 | 19.48 ^{d} ± 1.04 |
| | Extract (CE) | | |
| RE | 40 ppm Rosemary | 0.35 ^{a} ± 0.01 | 11.22 ^{b} ± 0.63 |
| | Extract (RE) | | |
| RE + CE | 60 ppm CE + 40 ppm RE | 0.28 ^{a} ± 0.02 | 5.52 ^{a} ± 0.31 |

The 2-factor interactions were again studied using 50-50 multivariate analysis of variance (50-50 Manova) described by Langsrud (2000, 2002). The analysis confirmed a strong 2-factor interaction between CE and RE on the inhibition of 2,4-heptadienal (p_{RE*CE}<0.001) and on the inhibition of 2,4-decadienal (p_{RE*CE}<0.001).

### Example of a Blend Composition

Table 14 shows an example of a liquid blend composition of chamomile and rosemary extract dissolved in propylene glycol.

TABLE 14
Blend composition

| Ingredients | g/kg | % |
|---|---|---|
| Chamomile Extract | 82.50 | 8.25 |
| Rosemary Extract | 55.00 | 5.50 |
| Propylene glycol | 862.50 | 86.25 |
| Total | 1000.00 | 100.00 |

The blend is used in mayonnaise in amounts of 50-2000 ppm based on the amount of mayonnaise.

### CONCLUSION

We have shown synergistic activity in respect of antioxidant activity when combining chamomile extract (CE) and rosemary extract (RE) to create an efficient multi-component antioxidant blend capable of prolonging the shelf-life of mayonnaise better than rosemary extract alone.

Two individual mayonnaise trials were conducted to demonstrate synergistic interaction of combining CE and RE. Determination of secondary oxidation products by gas chromatography-mass-spectroscopy with selecting ion monitoring (GC-MS-SIM) revealed a synergistic interaction between the CE and RE. As single ingredient, CE was ineffective, but in combination with RE a strong synergism appeared in delaying the development of 2,4-heptadienal and 2,4-decadienal.

### REFERENCES

Langsrud, Ø. (2002). 50-50 multivariate analysis of variance for collinear responses. The Statistician 51(3), pp. 305-317

Langsrud Ø. (2000), Fifty-Fifty MANOVA: Multivariate Analysis of Variance for Collinear Responses, Proceedings of The Industrial Statistics in Action 2000, vol. 2, pp. 250-264

Let, M. B., Jacobsen, C. & Meyer, A. S. (2004). Effects of fish oil type lipid antioxidants and presence of rapeseed oil on oxidative flavour stability of fish oil enriched milk. European Journal of Lipid Science and Technology, 106, pp. 170-182

Hartvigsen, K., Lund, P., Hansen, L. F. & Hølmer, G. (2000). Dynamic headspace of volatiles produced in fish oil enriched mayonnaise during storage. Journal of Agricultural and Food Chemistry, 48, pp. 4858-4867

Thorsen, M. A., & Hildebrandt, K. S. (2003). Quantitative determination of phenolic diterpenes in rosemary extracts: Aspects of accurate quantification. Journal of Chromatography A, 995, pp.119-125.

Nychas, G. -J . . . E., Skandamis, P . . . N . . . 2003 . . . Antimicrobials from herbs and spices. . In: Natural Antimicrobials for the Minimal Processing of Foods . . . Ed: S . . . Roller . . . CRC Press . . . Washington, USA.

Smid, E. J . . . and Gorris, L . G. M . . . 1999 . . . Natural antimicrobials for food preservation . . . In: Handbook of Food Preservation . . . Ed: M. S . . . Rahman . . . Marcel Dekker Inc . . . New York.

Loliger, J . . . 1989 . . . Natural Antioxidants . . . In: Rancidity in Food, edited by J. Allen and R. Hamilton . . . Elsevier Applied Science, New York, pp 105-124

Cuvelier, M . . . 0E., Richard, H., and Berset, C. 1996 . . . Antioxidative activity and phenolic composition of pilot-plant and commercial extracts of sage and rosemary . . . JAOCS 73: 645-652

U.S. Pat. No. 6,231,896

Wenkert et al. J. Org. Chem 30:2931, 1965)

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology, food science or related fields are intended to be within the scope of the following claims

1-5. (canceled)

6. A foodstuff according to claim 18, wherein extract (b) if from a plant of the genus Matricaria.

7. A foodstuff according to claim 18, wherein extract (b) is from a plant of the species Matricaria recurtita.

8. (canceled)

9. A foodstuff according to claim 18 wherein the composition comprises (c) an extract obtained from a plant of the Cynara family.

10. A foodstuff according to claim 9 wherein the plant of the Cynara family is selected from Cynara scolymus and Cynara cardunculus.

11. A foodstuff according to claim 9 wherein the plant of the Cynara family is Cynara scolymus.

12-13. (canceled)

14. A foodstuff according to claim 18, wherein the extract of (b) contains apigenin-7-O-glucoside in an amount of at least 0.1% (by weight, based on the weight of the extract of (b)).

15-16. (canceled)

17. A foodstuff according to claim 18 wherein the antioxidant composition inhibits the formation of 2,4-heptadienal and/or 2,4-decadienal.

18. A foodstuff comprising an anti-oxidant composition, wherein:
the antioxidant composition comprises:
(a) a rosemary extract comprising phenolic diterpenes in an amount of at least 1% (by weight, based on the weight of the extract) obtained from rosemary and less than 1% (by weight, based on the weight of the extract) flavor-inducing compounds and/or rosemary essential oils obtained from rosemary, and
(b) extract obtained from a plant of the genus Matricaria or of the genus Chamaemelum; and
the composition comprises a weight ratio of the extract in (a) to the extract in (b) of from 30:1 to 1:20.

19. A foodstuff according to claim 18 wherein the foodstuff is selected from mayonnaise, salad dressings, oil-in-water emulsions, margarines, low fat spreads, water-in-oil emulsions, dairy products, cheese spreads, processed cheese, dairy desserts, flavoured milks, cream, fermented milk products, cheese, butter, condensed milk products, ice cream mixes, soya products, pasteurised liquid egg, bakery products, confectionery products, fruit products, foods with fat-based or water-containing fillings, raw meat, cooked meat, raw poultry products, cooked poultry products, raw seafood products, cooked seafood products, ready to eat meals, pasta sauces and pasteurised soups.

20. A foodstuff according to claim 18 wherein the foodstuff is mayonnaise.

21. A process for preventing and/or inhibiting oxidation of a foodstuff, wherein:
the process comprises contacting the foodstuff with:
(a) an amount of rosemary extract comprising phenolic diterpenes in an amount of at least 1% (by weight, based on the weight of the extract) obtained from rosemary and less than 1% (by weight, based on the weight of the extract) flavor-inducing compounds and/or rosemary essential oils obtained from rosemary, and
(b) an amount of extract obtained from or obtainable from a plant of the genus Matricaria or of the genus Chamaemelum; and
the amounts of the extracts of (a) and (b) have a weight ratio of the extract of (a) to the extract of (b) of from 30:1 to 1:20.

22. A process according to claim 21 wherein the extracts of (a) and (b) are mixed with the foodstuff together.

23. A process according to claim 21 wherein the extracts of (a) and (b) are mixed with the foodstuff sequentially.

24. A process according to claim 21, wherein the foodstuff is selected from mayonnaise, salad dressings, oil-in-water emulsions, margarines, low fat spreads, water-in-oil emulsions, dairy products, cheese spreads, processed cheese, dairy desserts, flavoured milks, cream, fermented milk products, cheese, butter, condensed milk products, ice cream mixes, soya products, pasteurised liquid egg, bakery products, confectionery products, fruit products, foods with fat-based or water-containing fillings, raw meat, cooked meat, raw poultry products, cooked poultry products, raw seafood products, cooked seafood products, ready to eat meals, pasta sauces and pasteurised soups.

25-29. (canceled)

30. A kit for inhibiting oxidation of a foodstuff, wherein:
the kit comprises:
(a) a container comprising an amount of rosemary extract comprising phenolic diterpenes in an amount of at least 1% (by weight, based on the weight of the extract) obtained from rosemary and less than 1% (by weight, based on the weight of the extract) flavor-inducing compounds and/or rosemary essential oils obtained from rosemary,
(b) a containing comprising an amount of extract obtained from or obtainable from a plant of the genus Matricaria or of the genus Chamaemelum, and
(c) instructions for admixture and/or contacting the extracts of (a) and (b) with the foodstuff; and
the amounts of the extracts of (a) and (b) in the kit have a weight ratio of the extract of (a) to the extract of (b) of from 30:1 to 1:20.

31-34. (canceled)

35. A foodstuff according to claim 18, wherein the foodstuff comprises an emulsion.

36. A foodstuff according to claim 18, wherein the foodstuff comprises a salad dressing.

37. A foodstuff according to claim 18, wherein the extract of (a) is a deodorized extract.

38. A process according to claim 21, wherein the foodstuff comprises an emulsion.

39. A kit according to claim 30, wherein the foodstuff comprises an emulsion.
